(19) United States
(12) Patent Application Publication
(10) Pub. No.: US 2013/0008035 A1
(43) Pub. Date: Jan. 10, 2013

(54) COMPOSITE MATERIAL KNIFE TOOL

(76) Inventor: Hsieh Wen HSIUNG, Zhudong Township (TW)

(21) Appl. No.: 13/197,323

(22) Filed: Aug. 3, 2011

(30) Foreign Application Priority Data
Jul. 5, 2011 (TW) 100212282

(51) Int. Cl. B26B 3/00; B25G 1/10; B26B 9/00

(52) U.S. Cl. 30/342; 30/350; 30/345

(57) ABSTRACT

A composite material knife tool, comprising: a knife blade, lower rim of which is a knife-edge portion, at least a hole is provided on said knife blade; and a knife handle, which is formed integrally and extends to envelop said knife blade and said holes, thus exposing said knife-edge portion for cutting objects. Said composite material knife tool uses the smallest knife blade to achieve full utilization of knife tool, hereby realizing cost reduction effectively.

### BACKGROUND OF THE INVENTION

1. Field of the Invention

The present invention relates to a knife tool, and in particular to a composite material knife tool, the cost of which can be reduced effectively.

2. The Prior Arts

Since ancient times, knife has been utilized extensively in our daily life. In pre-historic age, rock is utilized as material to make knife tools, for which the edge of the rock is grinded and polished to be sharp for cutting objects or killing animals. Therefore, the utilization of knife is closely related to our daily life, and it has become an indispensable tool.

Refer to FIG. 1 for a schematic diagram for a conventional knife tool according to the prior art. As shown in FIG. 1, the whole knife blade 20 is grinded and polished to have a knife-edge portion 202, and is installed on a knife handle 24. However, in addition to knife-edge portion 202, the remaining portions of knife blade 20 are not used in cutting objects, and that constitutes a waste of cost of the knife blade. Furthermore, the knife blade 20 exposed to air tends to incur chemical reactions, hereby resulting in the knife becoming dull, and it is difficult to cut object.

Therefore, presently, the design and application of a knife tool of the prior art are not quite satisfactory, and it has much room for improvements.

### SUMMARY OF THE INVENTION

In view of the problems and shortcomings of the prior art, the present invention provides a composite material knife tool, that can solve the problem of the prior art.

A major objective of the present invention is to provide a composite material knife tool, for which minimum knife blade cost is required to achieve full utilization of knife tool, in realizing cost reduction effectively.

Another objective of the present invention is to provide a composite material knife tool, wherein, knife handle is formed integrally to envelop the upper rim of knife blade, to replace the knife body structure of the prior art.

In order to achieve the above-mentioned objective, the present invention provides a composite material knife tool, comprising: a knife blade, the lower rim of which is a knife-edge portion, at least a hole is provided on the knife blade; and a knife handle, which is formed integrally and extends to envelop the knife blade and the holes, thus exposing the knife-edge portion.

Therefore, an important objective of the present invention is to reduce the cost of knife blade, such that smaller knife blade can be used to achieve the same effect of bigger knife blade.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a conventional knife tool according to the prior art;

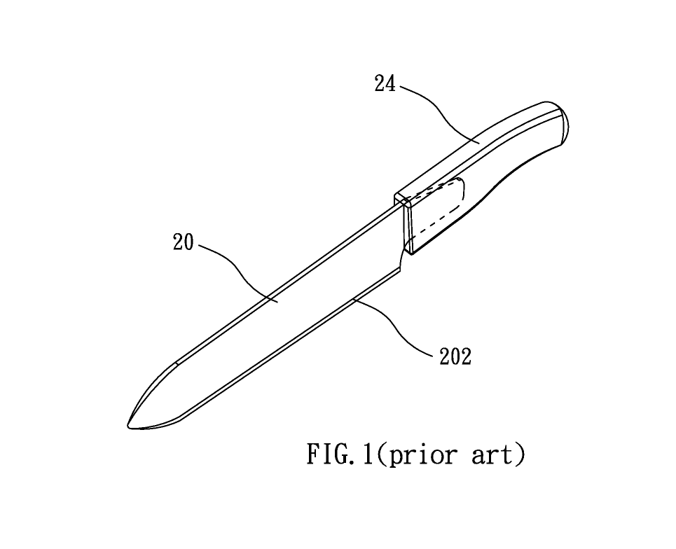

FIG. 2 is a perspective view of a composite material knife tool according to the present invention;

FIG. 3 is a schematic diagram of knife blade used in a composite material knife tool according to the present invention;

FIG. 4 is a schematic diagram of outer appearance of a composite material knife tool according to the present invention; and

FIG. 5 is a cross section view of the composite material knife tool along A-A′ line of FIG. 4 according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

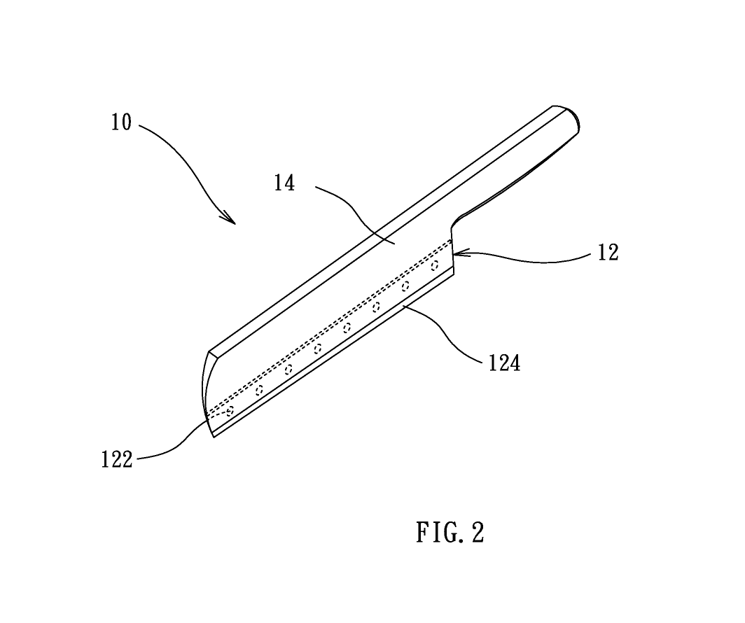

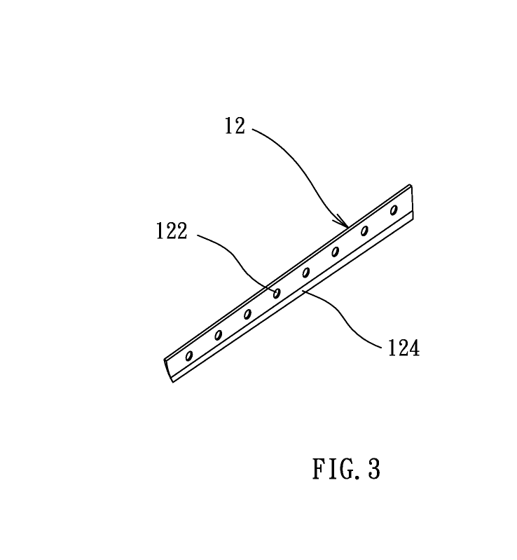

Refer to FIGS. 2 and 3 respectively for a perspective view of a composite material knife tool according to the present invention; and a schematic diagram of knife blade used in a composite material knife tool according to the present invention. As shown in FIGS. 2 and 3, the composite material knife tool 10 of the present invention mainly comprises: a knife blade 12, made of stainless steel, zirconium oxide, silicon nitride, or boron nitride, wherein, on the knife blade 12 is provided with at least a hole 122, in this embodiment, a plurality of holes 122 utilized are taken as an example, such that the lower rim of the knife blade 142 is a sharp knife-edge portion 124; and a knife handle 14 is formed integrally and extends to envelop the knife blade 12, and it also extends to envelop and fill the holes 122 on the knife blade 12, but not envelop the knife-edge portion 124 on the knife blade, hereby exposing 2.5 to 3 mm knife-edge portion for cutting objects.

In the descriptions mentioned above, the knife handle 14 is made of plastic or Melamine or other materials, such as the ARBOFORM, ARBOFILL series products made by a German Company TECNARO, such that in case the knife handle 14 is made of plastic, then injection molding is used to form the knife handle 14 integrally to envelop the knife blade 12 and fill the holes 122; or in case the knife handle 14 is made of Melamine, then press molding is used to form the knife handle 14 integrally to envelop the knife blade 12 and fill the holes 122. Both methods mentioned above utilize the material of knife handle 14 to fill the holes 122, thus enhancing the strength binding the knife handle 14 and the knife blade 12.

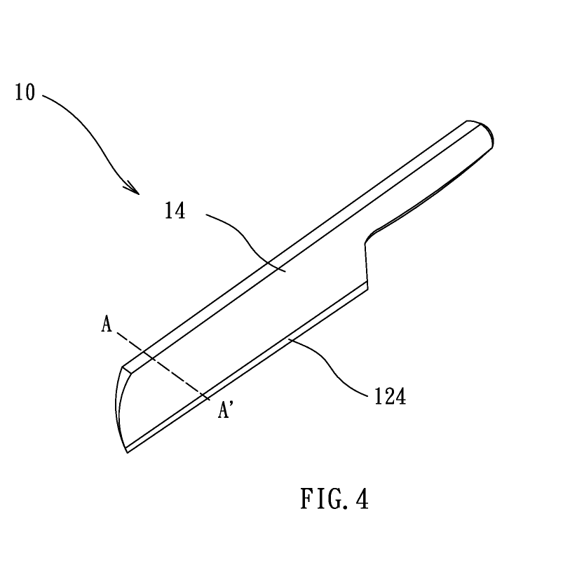

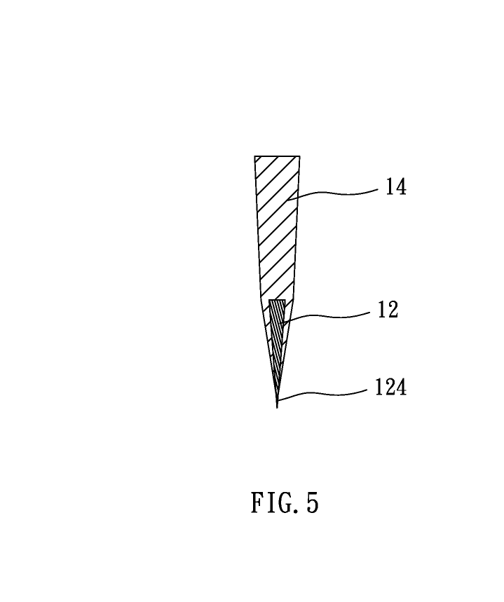

Then, refer to FIG. 4 for a schematic diagram of outer appearance of the composite material knife tool of the present invention. As shown in FIG. 4, the knife handle 14 extends and envelops the entire knife blade 12, exposing only the knife-edge portion 124 for cutting objects. Refer to FIG. 5 for cross section view of the composite material knife tool along A-A′ line of FIG. 4 according to the present invention. In the present invention, knife handle 14 is formed integrally to extend and envelop directly the knife blade 12, so that knife handle 14 replaces directly the knife body structure of the prior art, hereby exposing only the knife-edge portion 124 to cut objects as required. Moreover, for convenience of easy holding the knife, the holding portion of the knife handle can be designed into shape for easy handling by the user.

Therefore, the present invention utilizes the knife blade of minimum cost to achieve the same effect of conventional knife tool, in realizing cost reduction effectively.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A composite material knife tool, comprising:
a knife blade, having at least a hole disposed thereon, and lower rim of said knife blade is provided with a knife-edge portion; and
a knife handle, formed integrally to extend to envelop said knife blade and said hole, thus exposing said knife-edge portion.

2. The composite material knife tool as claimed in claim 1, wherein said knife blade is made of stainless steel, zirconium oxide, silicon nitride, or boron nitride.

3. The composite material knife tool as claimed in claim 1, wherein said knife handle is made of plastic or Melamine

4. The composite material knife tool as claimed in claim 3, wherein said knife handle is made of plastic material by means of injection molding.

5. The composite material knife tool as claimed in claim 3, wherein said knife handle is made of melamine material by means of press molding.
